(19) United States
(12) Patent Application Publication
(10) Pub. No.: US 2019/0176212 A1
(43) Pub. Date: Jun. 13, 2019

(54) RIVETTING APPARATUS FOR ASSEMBLY PLANTS

(71) Applicant: COSBERG S.p.A., Terno d'Isola, Bergamo (IT)

(72) Inventor: Gianluigi Carlo VISCARDI, Sotto il Monte Giovanni XXIII, Bergamo (IT)

(73) Assignee: COSBERG S.p.A., Terno d'Isola, Bergamo (IT)

(21) Appl. No.: 16/324,017

(22) PCT Filed: Jul. 27, 2017
(86) PCT No.: PCT/IB2017/054573

§ 371 Date: Feb. 7, 2019

(30) Foreign Application Priority Data
Aug. 8, 2016 (IT) 102016000083531

(51) Int. Cl. B21J 15/14; B21J 15/02; B21J 15/32; B21J 15/12

(52) U.S. Cl. CPC B21J 15/14; B21J 15/02; B21J 15/32; E05D 5/12; E05Y 2600/508; E05Y 2800/45; B21J 15/12

(57) ABSTRACT

A riveting apparatus (1) is for the application and riveting a rivet (6) to a component (2, 4) of an article (1a, 1b) being processed in a work region (96) of the apparatus. The riveting apparatus includes a rivet insertion device (30) for the insertion of the rivet into the component and a riveting device (40) for the riveting of the rivet.

The object of the present invention is a riveting apparatus for assembly plants, for example for multicomponent articles, such as hinges.

In the field of assembly plants of articles, it is essential that the machines are able to produce large volumes in a short time. Only in the presence of these features, in fact, the system cost can be amortized in a short time and the investment can be profitable.

In the field of the manufacture of machines for such plants, therefore, there is a tendency to create ever faster lines, sometimes able to produce tens of thousands of articles a day. It is however essential to minimise waste and obtain articles having optimal functionality.

This is even more evident in the case of assembly of multicomponent articles, in which the components are intended for relative movements, as is the case with hinges, for example for windows and doors, furniture, appliances and the like.

The object of the present invention is to provide a riveting apparatus that meets the needs of the sector.

Such an object is achieved by a riveting apparatus according to claim 1. The dependent claims describe alternative embodiments.

The features and the advantages of the riveting apparatus according to the present invention will appear more clearly from the following description, made by way of an indicative and non-limiting example with reference to the following figures, in which:

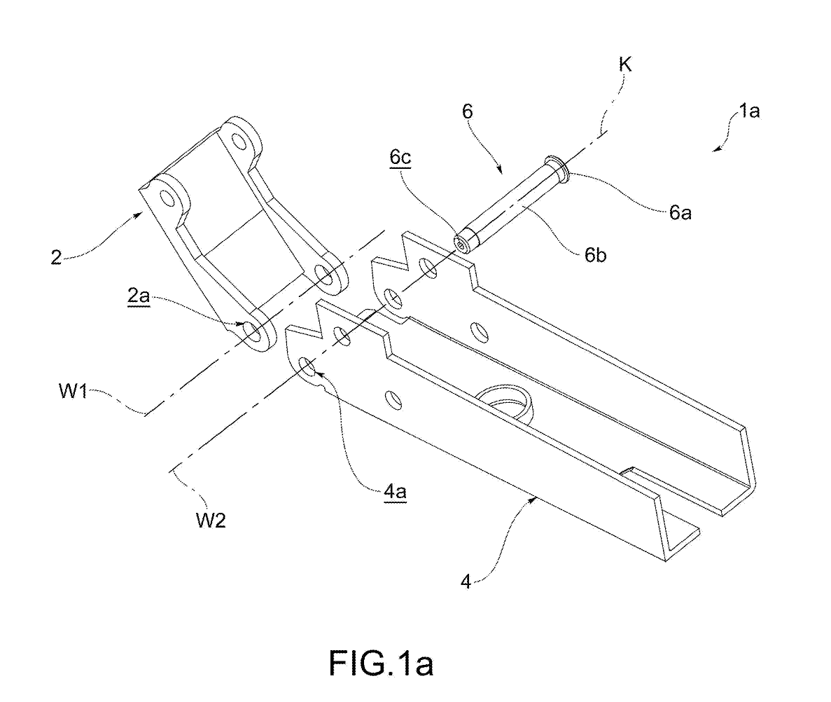

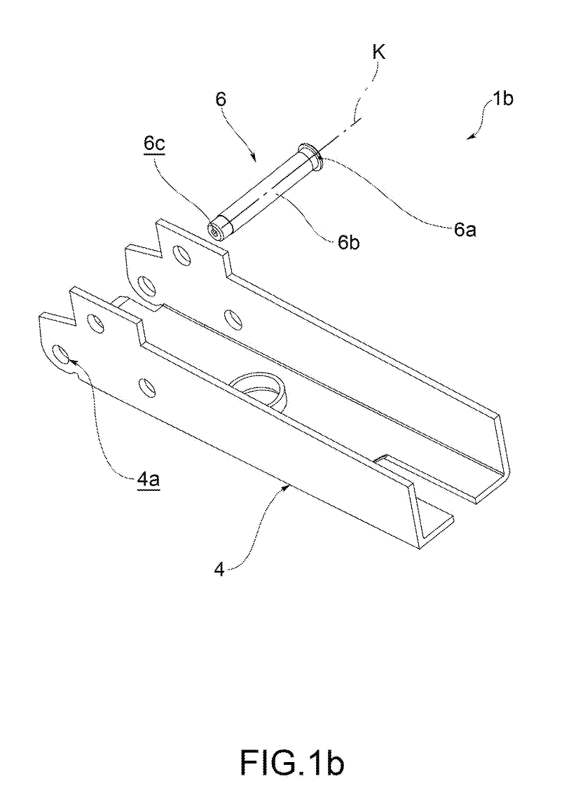

FIG. 1a shows a multicomponent article to be riveted and assembled, such as a hinge; the article does not in itself constitute an object of the present invention;

FIG. 1b shows an article to be riveted; the article does not in itself constitute an object of the present invention;

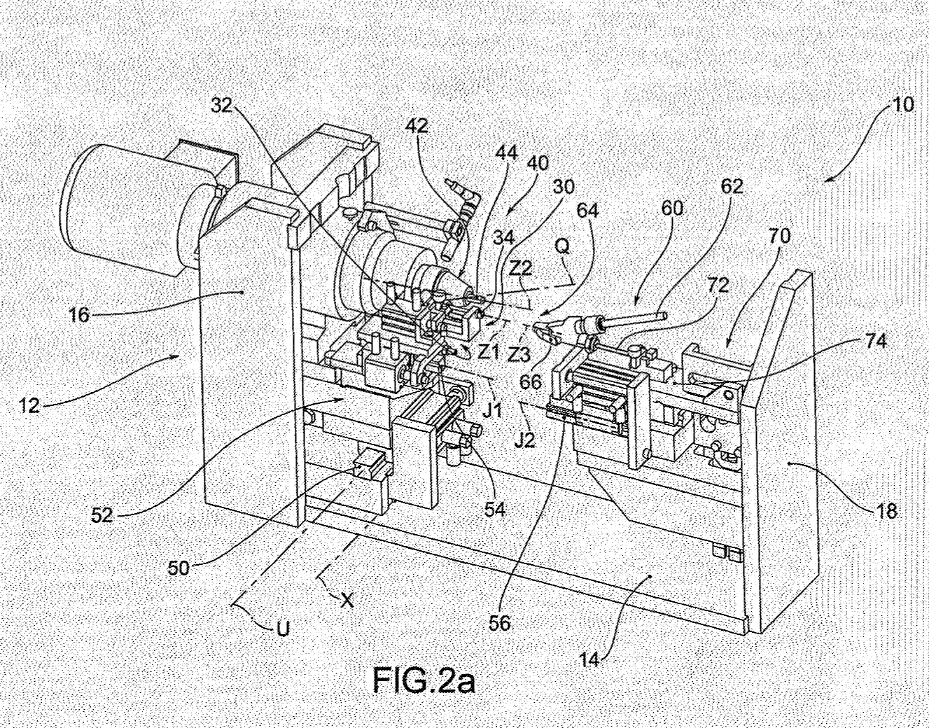

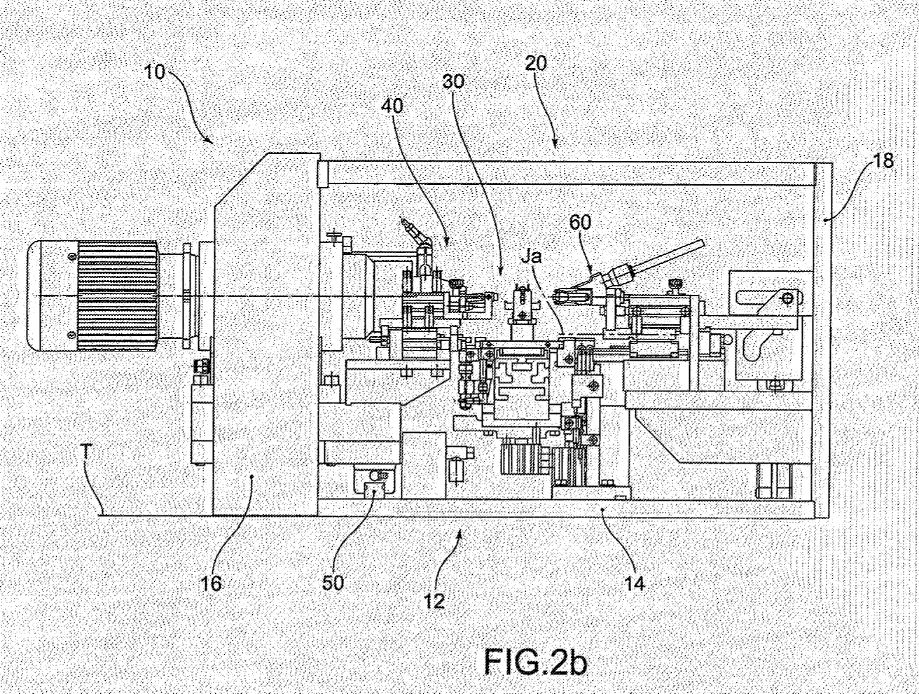

FIGS. 2a and 2b show a riveting apparatus according to an embodiment of the present invention;

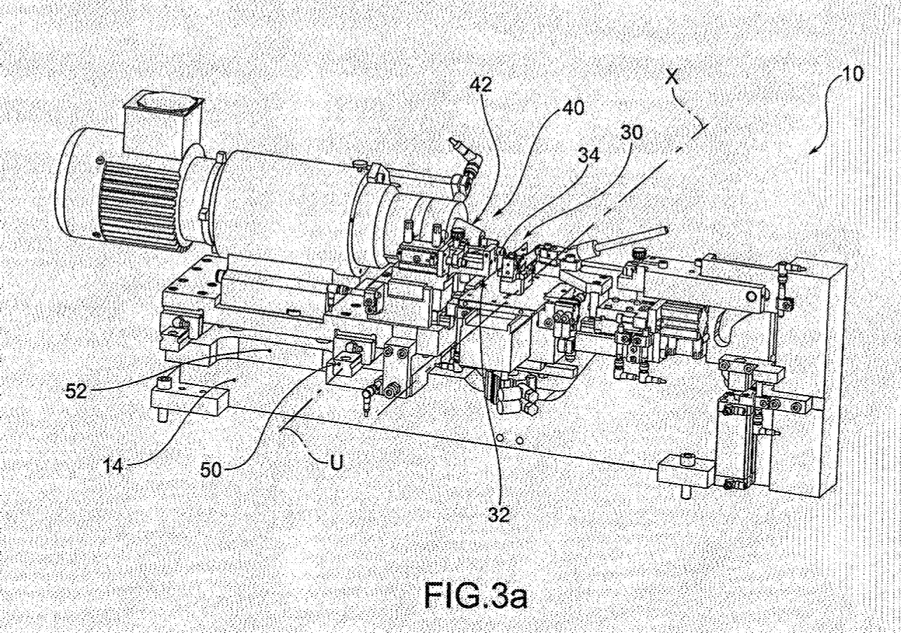

FIGS. 3a and 3b show a riveting apparatus according to an embodiment of the present invention;

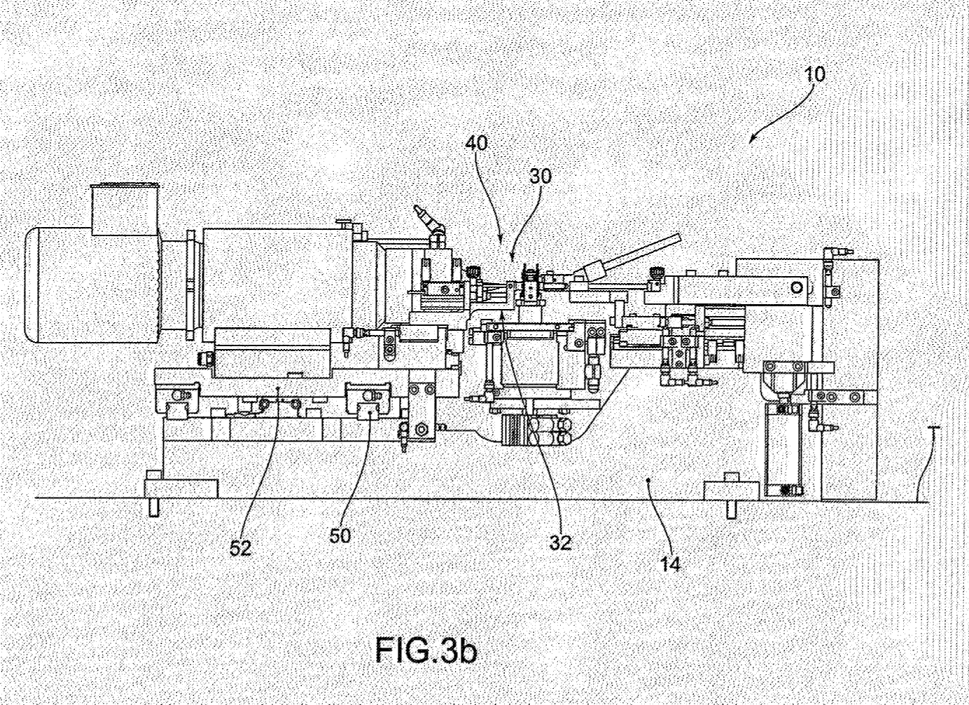

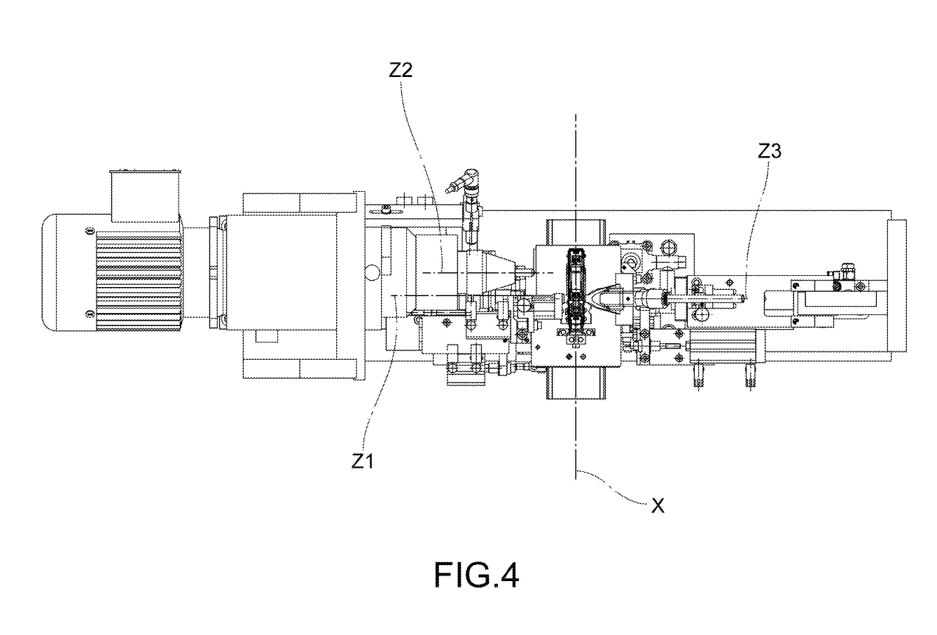

FIG. 4 shows a top plan view of the riveting apparatus according to the invention, in a rivet insertion configuration;

FIGS. 5 to 7 show working steps of the apparatus in the rivet insertion configuration;

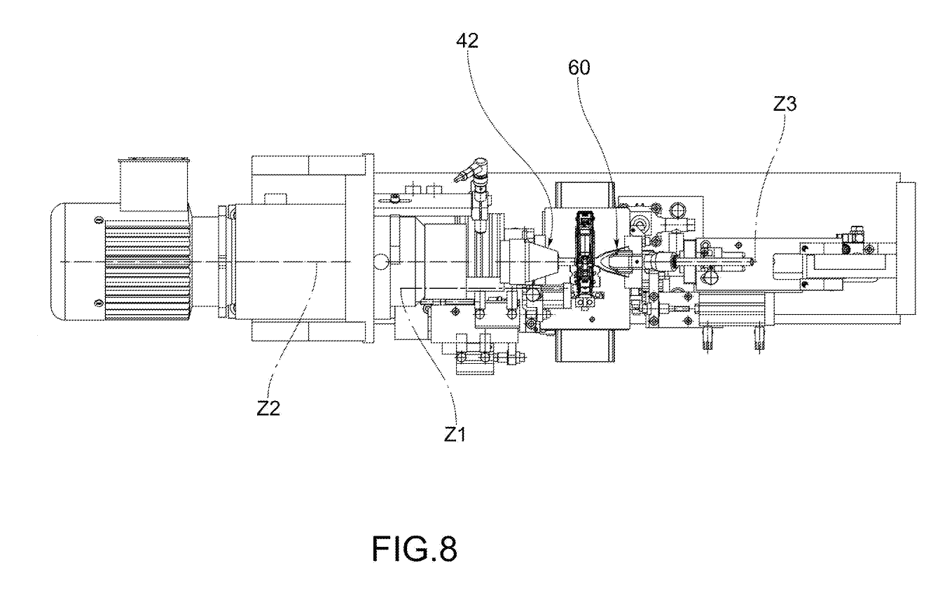

FIG. 8 shows a top plan view of the riveting apparatus in a riveting configuration;

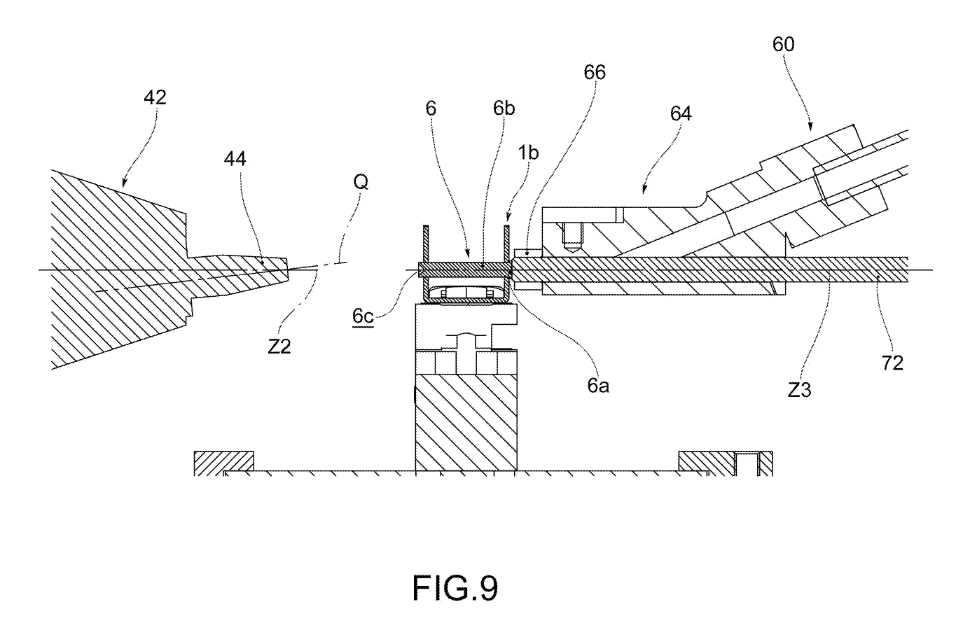

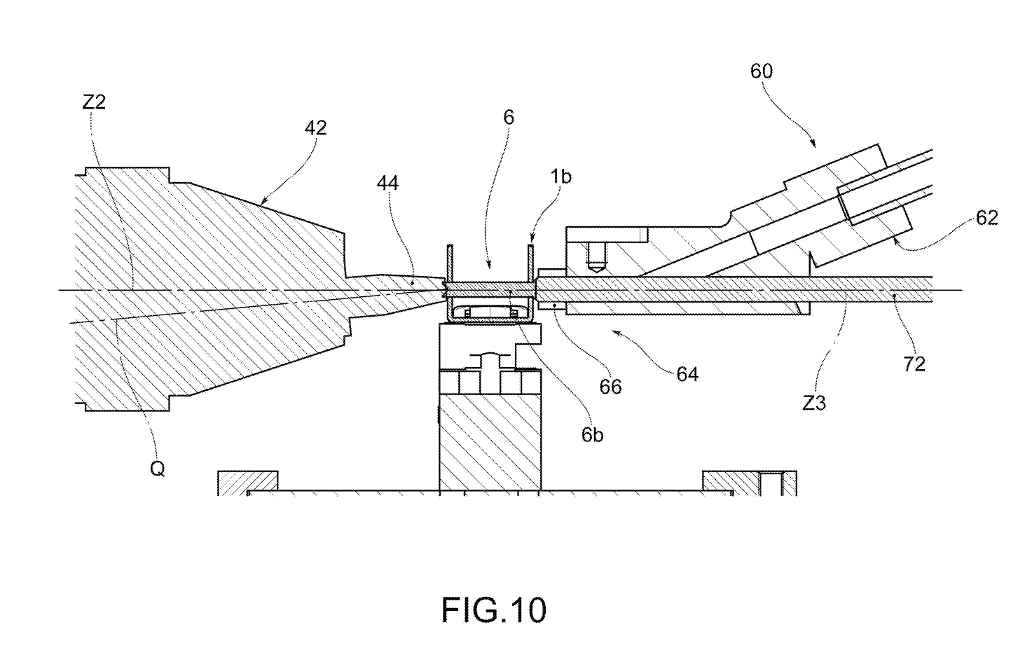

FIGS. 9 and 10 show working steps of the apparatus in the riveting configuration;

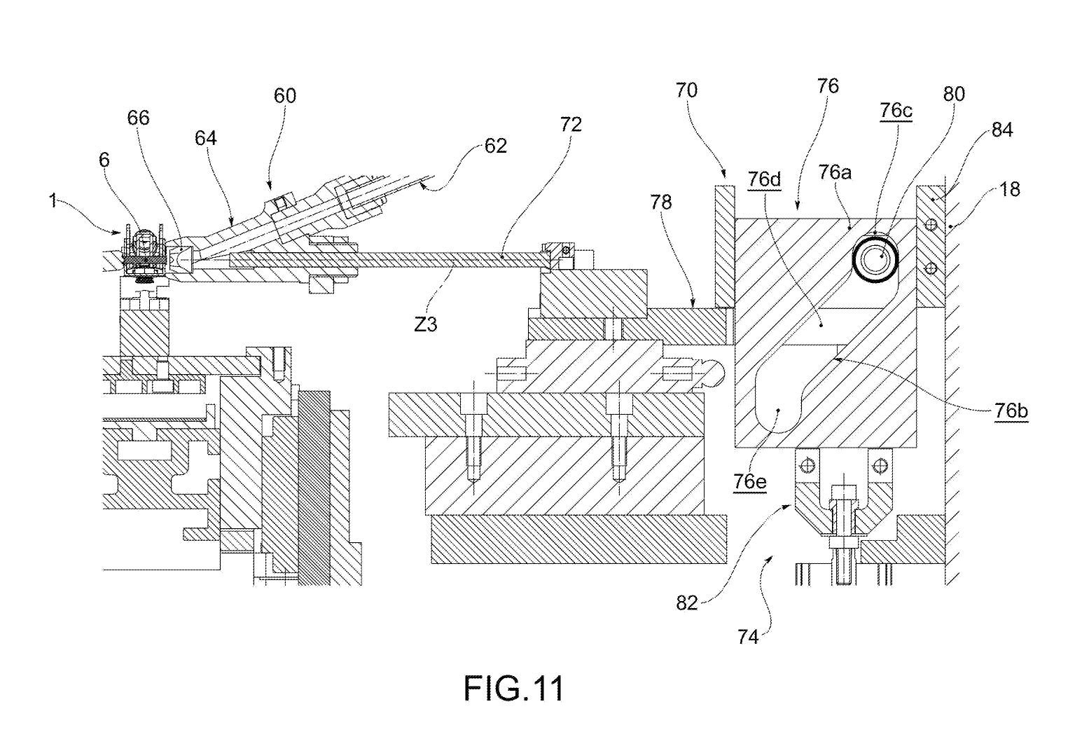

FIG. 11 shows an insertion and abutment group of the apparatus, in a configuration in which a cam is in a first limit position;

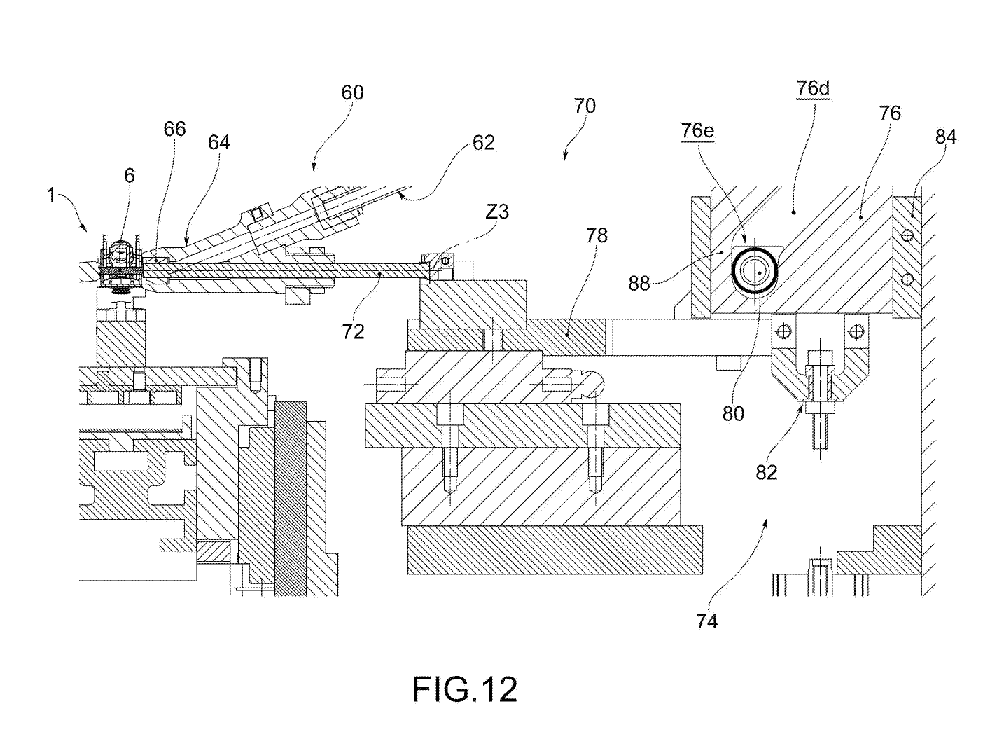

FIG. 12 shows the insertion and abutment group of the apparatus, in a configuration in which the cam is in a second limit position;

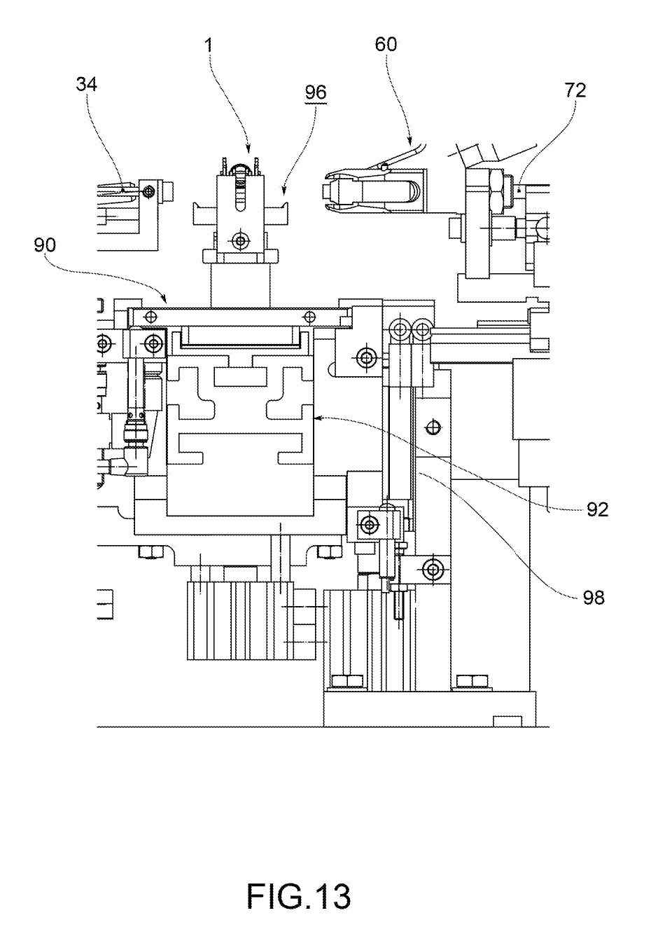

FIG. 13 shows lifting means of the apparatus;

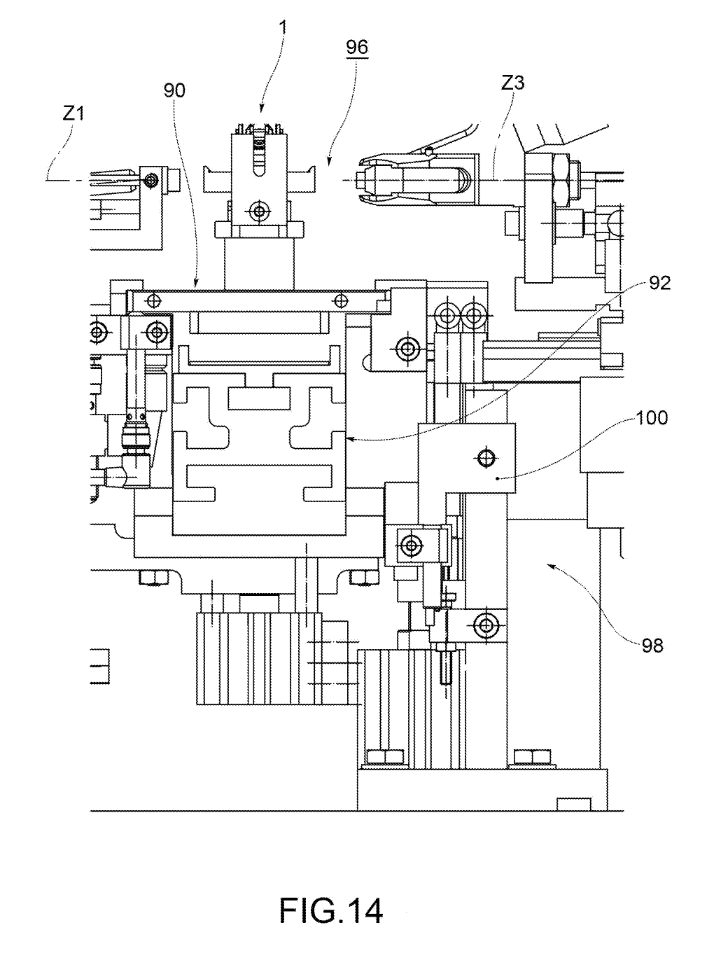

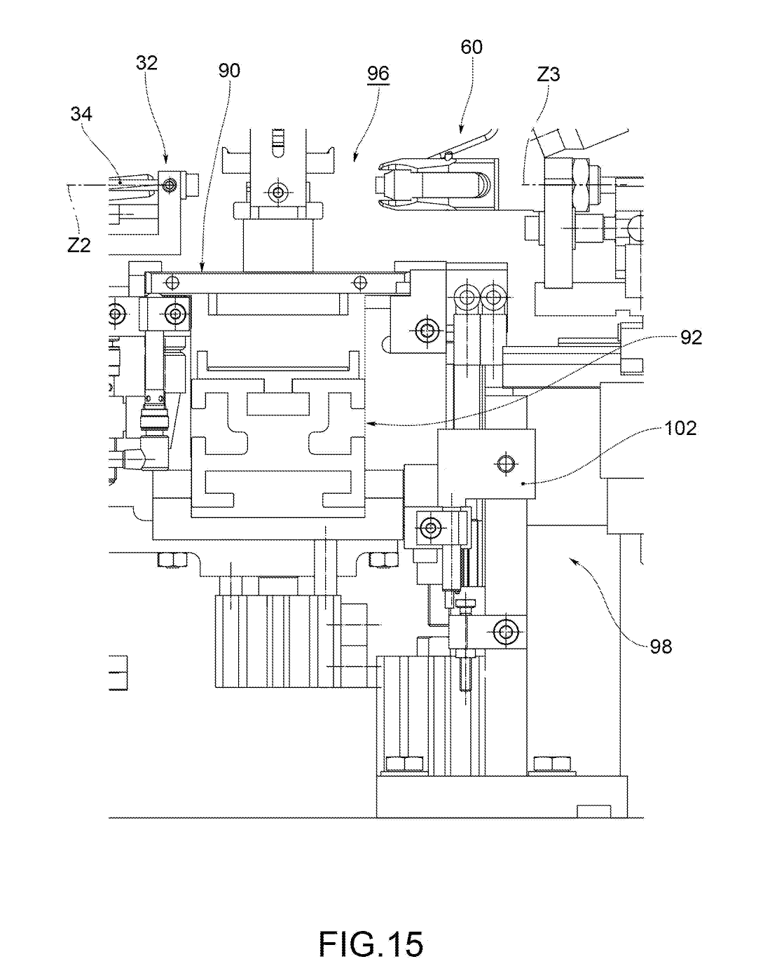

FIGS. 14 and 15 show the lifting means provided with different end stop blocks;

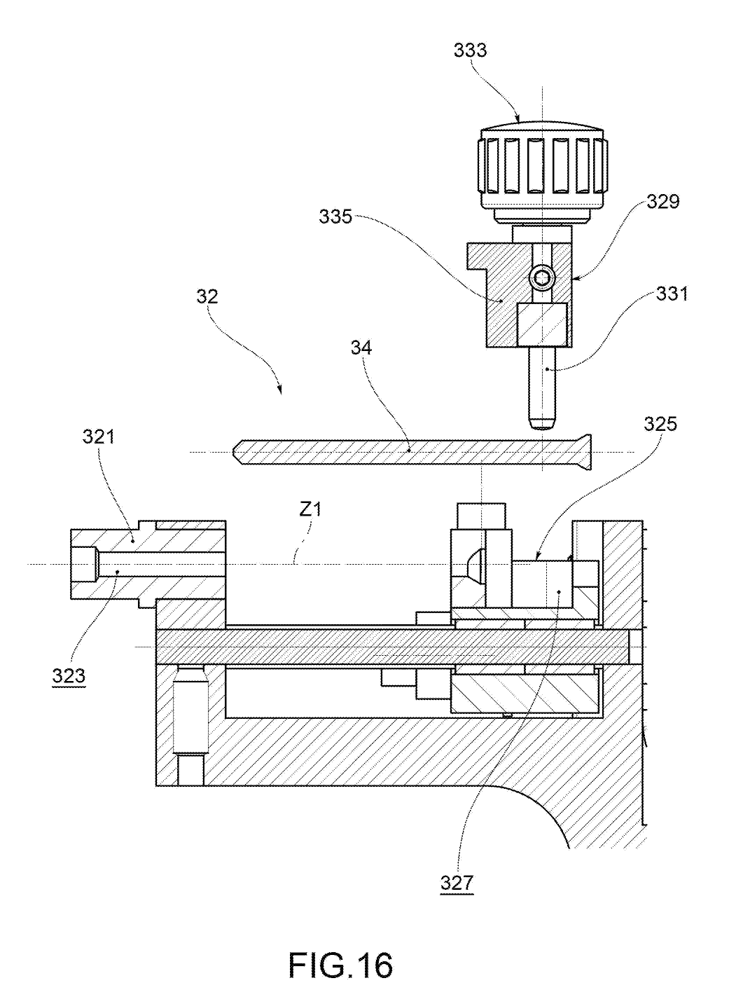

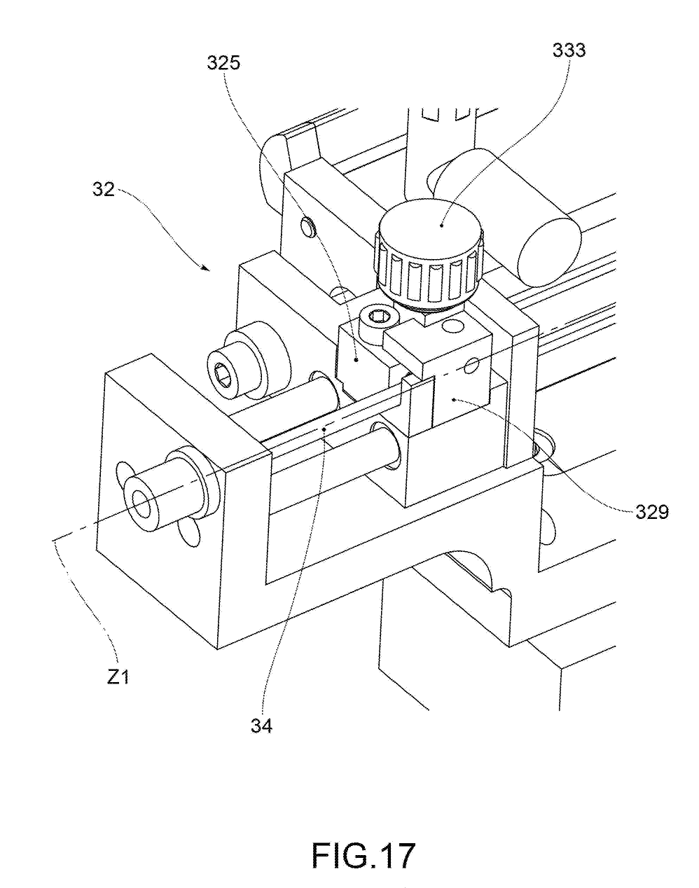

FIGS. 16 and 17 show a picking group of the riveting apparatus according to an embodiment.

With reference to the example in FIG. 1a, reference numeral 1a denotes as a whole a multicomponent article to be assembled, for example a hinge, comprising a first component 2 provided with a first through hole 2a having a first hole axis W1, a second component 4 provided with a second through hole 4a having a second hole axis W2, and a rivet 6 intended to be inserted in the aligned holes 2a, 4a and engage the first and the second component, thus hinging them.

According to an exemplary embodiment, rivet 6 consists of a head 6a to be riveted, i.e. to be plastically deformed, a shank 6b, protruding from the head along a rivet axis K, having a slit 6c a the free end thereof.

FIG. 1b shows a further example of article 1b to be riveted, consisting of component 4 provided with the through hole 4a, to be riveted through rivet 6 intended to be inserted into hole 4a.

With reference to the embodiment in FIGS. 2a and 2b, a riveting apparatus 10 comprises a support frame 12 comprising a base 14, resting on a horizontal ground plane T, a first vertical shoulder 16 and a second vertical shoulder 18, supported by base 14 and protruding vertically therefrom, and preferably at least at least one crosspiece 20, which superiorly joins said vertical shoulders panels 16, 18.

The frame thus forms a closed-loop structure, crossed by a transport system, such as a conveyor belt 92 movable along an advancement direction X.

According to a further embodiment (FIGS. 3a and 3b), the riveting apparatus 10 comprises base 14, resting on the horizontal ground plane T, and an open support structure, crossed by the transport system movable along the advancement direction X.

Moreover, according to the invention, the riveting apparatus 10 comprises a rivet insertion device 30 and a riveting device 40, mutually integrated.

In other words, the rivet insertion device 30 and the riveting device 40 share certain structural parts and provide coordinated functionalities. In addition, preferably, they are both supported by base 14.

The riveting apparatus 10 comprises a longitudinal guide 50, having extension along a longitudinal direction U, oriented along the advancement direction X (for example, parallel thereto), arranged integral with the base or with one of the two shoulders 16, 18, for example with the first vertical shoulder 16.

The riveting apparatus 10 further comprises a mobile support 52 slidably engaged with the longitudinal guide 50, and first movement means, for example pneumatic, adapted to move the mobile support 52 on said longitudinal guide 50 along the longitudinal direction U.

The insertion device 30 comprises a picking group 32 adapted to accompany the insertion of rivet 6 into hole 4a, arranged on board the mobile support 52.

In particular, to this end, the picking group 32 comprises a picking rod 34 having extension and translatable along a picking direction Z1.

The riveting device 40 instead comprises a riveting head 42 suitable to plastically deform the free end of rivet 6, also placed on board the mobile support 52, longitudinally flanking the picking group 32.

The riveting head 42 is translatable along a riveting direction Z2 orthogonal to the advancement direction X and comprises a rotatable riveting tip 44, intended to come into contact with the free end of rivet 6.

Preferably, said tip 44 has an extension along a tip axis Q, coincident with the axis of rotation, tilted with respect to the riveting translation direction Z2 of head 42.

According to an embodiment variant, the tip has a projection at the end, preferably rounded, suitable for being at least partially inserted into the rivet slit.

In addition, the riveting apparatus 10 comprises a secondary transverse guide 54, having extension along a transverse direction J1 orthogonal to the advancement direction X, placed on board the mobile support 52 and on which is the picking group 32 is placed, and second movement means, such as pneumatic, suitable for moving the picking group 32 along said transverse direction J1 for a movement of approach of the picking group 32 to article 1a, 1b being processed.

The riveting apparatus 10 further comprises a rivet feed group 60, such as supported by the second vertical shoulder 18.

The riveting apparatus 10 further comprises a primary transverse guide 56, having extension along a transverse direction J2 orthogonal to the advancement direction X, on which the rivet feed group 60 is slidably engaged, and third movement means, such as pneumatic, suitable for moving the rivet feed group 60 to approach it to article 1a, 1b being processed.

The rivet feed group 60 comprises a tubular conduit 62 and a jaw group 64 placed at the end of the tubular conduit 62; the rivets are fed in succession to the tubular conduit 62 and pneumatically, they are pushed individually into the jaw group 64.

The jaw group 64 comprises a pair of elastic jaws 66 that clamp the rivet and arrange it so that shank 6b is aligned along an insertion direction Z3 orthogonal to the advancement direction X.

The riveting apparatus 10 is suitable for switching from a rivet insertion configuration to a riveting configuration. In the rivet insertion configuration (FIG. 4), support 52 is in a first longitudinal position, such that the picking axis Z1 is aligned with the insertion axis Z3; in the riveting configuration (FIG. 8), support 52 is in a second longitudinal position, such that the riveting axis Z2 is aligned with the insertion axis Z3.

Moreover, the riveting apparatus 10 comprises an insertion and abutment group 70 cooperating with the rivet feed group 60 for inserting the rivet into hole 4a of article 1b and with the riveting head 42 for riveting said rivet.

The insertion and abutment group 70 comprises a main rod 72 coaxial to the insertion direction Z3 and translatable along said direction Z3. In particular, the main rod 72 crosses the jaw group 64 and faces towards the region between said jaw group 64 and said picking group 32.

According to FIGS. 11 and 12, in order to move the main rod 72, the insertion and abutment group 70 comprises movement means.

For example, said movement means comprise a cylinder-piston group.

According to a preferred embodiment, said movement means are cam movement movement means 74.

Preferably, said cam movement means 74 comprise a cam 76 and a driven body 78, having an engagement element slidably engaged with cam 76 and integral in translation with the main rod 72.

Moreover, the cam movement means 74 comprise actuation means 82, such as pneumatic, for moving cam 76. Preferably, said actuation means are suitable for moving cam 76 vertically.

For example, cam 76 is translatable between a first limit position, such as lowered, which corresponds to a retracted limit position of the main rod 72 (FIG. 11) and a second limit position, such as raised, which corresponds to an advanced limit position of the main rod (FIG. 12).

Moreover, cam 76, in the direction orthogonal to the insertion direction Z3, is in abutment with a fixed shoulder 84, for example with the vertical shoulder 18.

For example, said insertion and abutment group 70 comprises a shoulder 84, with which the cam is in contact and vertically slidable.

Preferably, cam 76 consists of a cam body 76a, on which a groove 76b is formed in which the engagement element 80 moves integral with the main rod 72.

The shape of groove 76b determines the movement features of the main rod 72.

In particular, groove 76b comprises an upper limit compartment 76c, in which the engagement element 80 is accommodated when the cam is in the first limit position, an intermediate tilted stretch 76d and a lower limit compartment 76e, in which the engagement element 80 is accommodated when the cam is in the second limit position.

The lower limit compartment 76e is delimited in the insertion direction Z3, at the front, by an abutment wall 88 of the cam body 76a.

In the rivet insertion configuration of the riveting apparatus 10, in an initial configuration of the insertion device 30 (FIG. 5), the picking group 32 is flanked to article 1b being processed, by the actuation of the second movement means that carry out the translation of said picking group 32 along the secondary transverse guide 54, and the picking rod 34 is in an initial retracted position.

At the same time, the rivet feed group 60 is flanked to article 1b being processed by the actuation the third movement means that carry out the translation of said rivet feed group 60 along the primary transverse guide 56 and rivet 6 to be assembled is picked by the jaw group 64, so that shank 6b is aligned in the insertion direction Z3.

The main rod 72 of the insertion and abutment group 70 is in a retracted limit position, in which it does not engage rivet 6. Therefore, cam 76 is the first limit position (FIG. 11).

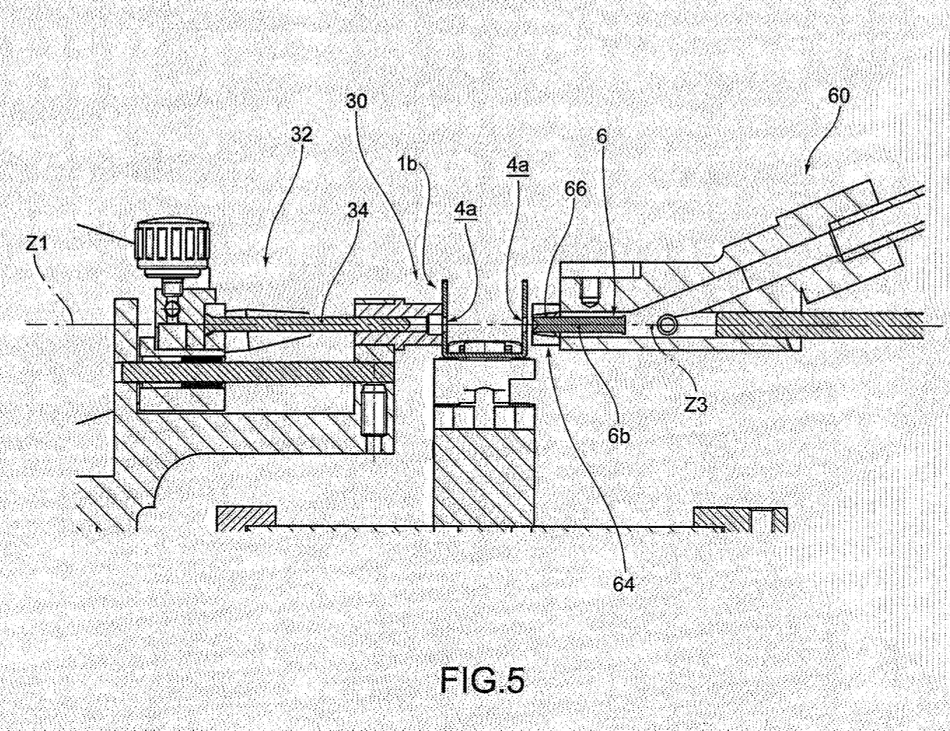

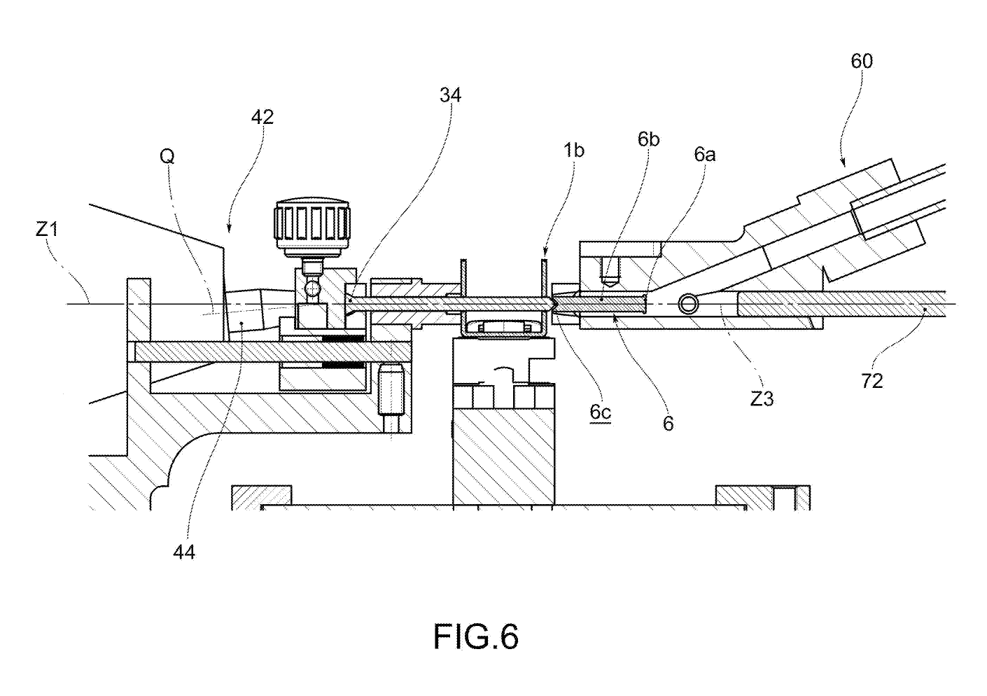

In a subsequent picking start configuration of the insertion device 30 (FIG. 6), the picking rod 34 is translated to an advanced limit position, in which it crosses the region in which article 1b is, in particular so as to cross hole 4a and engage rivet 6 on the other side, particularly fitting into slit 6c thereof.

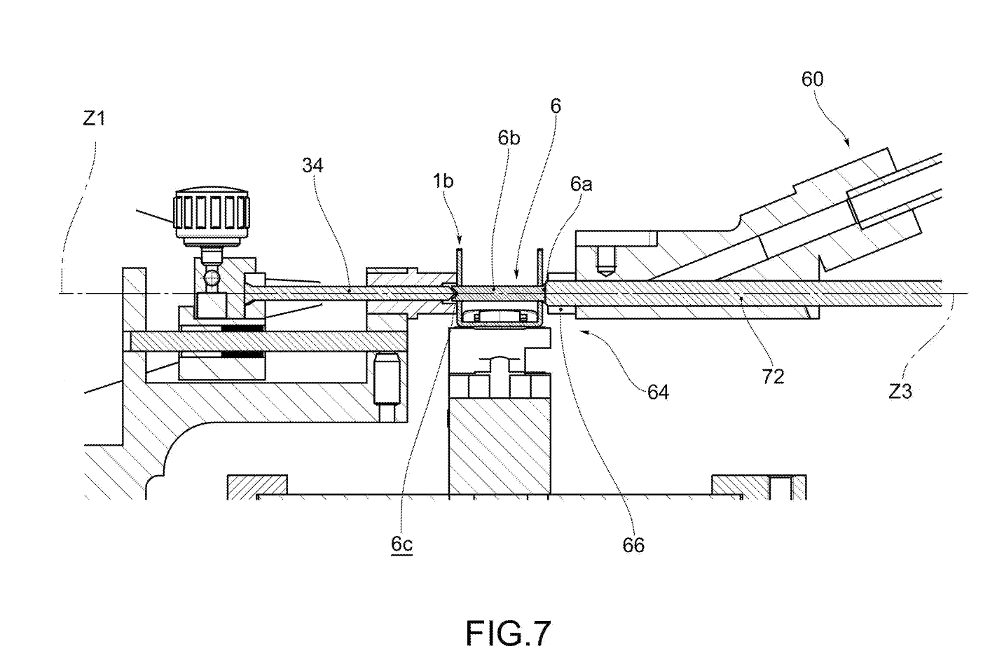

In a subsequent picking configuration of the insertion device 30 (FIG. 7), the main rod 72 is translated to an advanced limit position and the picking rod 34 simultaneously retracts towards the retracted limit position.

Rivet 6 is thus pushed by the main rod 72 which crossing the jaw group 64 widens jaws 66, allowing the passage of head 6a of rivet 6, and simultaneously accompanied through hole 4a by the picking rod 34, engaged into slit 6c.

Due to the translation of the main rod 72, cam 76 is brought to the second limit position (FIG. 12).

Preferably, the riveting apparatus comprises means for measuring the length of the rivet suitable to provide a measure of the length of the rivet.

According to an embodiment, said measurement means comprise an electronic device for detecting the stroke of the picking rod, an electronic device for detecting the stroke of the main rod and a processing device, operationally engaged with said electronic devices. The electronic device for detecting the stroke of the picking rod detects the forward stroke and the return stroke of the rod, while the electronic device for detecting the stroke of the main rod detects the forward stroke of the main rod. Knowing the distance between the initial retracted position of the picking rod 34 and the limit retracted position of the main rod 72 (which is a constructive parameter), the rivet length can be calculated as a function of the forward stroke of the picking rod, of the return stroke of the picking rod and of the forward stroke of the main rod.

Subsequently, the riveting apparatus 10 switches to the riveting configuration (FIG. 8), in which support is in the second longitudinal position, so that the riveting axis Z2 is aligned with the insertion axis Z3.

In the riveting configuration of apparatus 10, in an initial configuration (FIG. 9), the riveting head 42 is in a retracted limit position, in which it is spaced apart from the region in which article 1b is, and specifically spaced from the end of rivet 6.

The main rod 72 remains in the advanced limit position, defined by cam 76 in the second limit position.

In a subsequent riveting operating configuration (FIG. 10), the riveting head 42 is in an advanced limit position in which it rotates and plastically deform the end of rivet 6, thereby performing the riveting.

During the crushing of the end of the rivet, head 6a of rivet 6 is in abutment against the main rod 72, which thus acts as an abutment.

In particular, the action exerted by the riveting head 42 on rivet 6 for riveting is axially transmitted to the main rod 72 and hence to the fixed abutment, such as the vertical shoulder 18, through the driven body 78, the abutment wall 88 of the cam body 76a and preferably, shoulder 84.

Alternatively, the cylinder-piston group of the movement means forms an abutment for the main rod.

Preferably, the riveting apparatus comprises means for measuring the hardness of the rivet suitable to provide a measure of the hardness of the rivet.

According to an embodiment, said rivet hardness measurement are suitable for expressing a measure of hardness as a function of the riveting time with the same number of revolutions of the riveting tip or as a function of the current absorbed by the riveting head.

According to a further embodiment, said rivet hardness measurement means comprise a load cell which detects the compression action acting on the rivet.

Article 1b being processed is moved through the transport system comprising, for example, a pallet 90 of a conveyor belt 92, which moves along said advancement direction X (FIGS. 13, 14, 15).

In order to carry out a predefined assembly step, pallet 90 with article 1 is stationed in a region 96 comprised between the rivet feed group 60 on the one hand and the picking group and the riveting head 42 on the other.

The riveting apparatus 10 preferably comprises lifting means 98 operable to lift pallet 90 to a predefined height.

Preferably, said lifting means 98 are pneumatic and comprise a cylinder-piston group.

Preferably, moreover, said lifting means 98 comprise interchangeable blocks 100, 102 which realise an end stop for said piston, so as to position pallet 90, and thus article 1b being processed, so that hole 4a is vertically aligned with the picking Z1 or insertion Z3 direction.

Advantageously, this allows assembling products having dimensional differences without performing adjustments on the members of the devices or of the riveting apparatus groups, but simply using the appropriate block 100, 102.

According to a further embodiment (FIGS. 16 and 17), the picking rod 34 of the picking group 32 is replaceable.

In particular, the picking group 32 comprises a bush 321 provided with a through hole 323 which defines the picking direction Z1. In normal operation, the picking rod 34 protrudes from bush 321 towards article 1b being processed.

The picking group 32 further comprises a fixed support body 325 provided with a rod seat 327.

The picking rod 34 can be housed, at one end, in the rod seat 327 so as to be inserted into the through hole 323 of bush 321.

Additionally, the picking group 32 comprises a block 329, fixable to the support body 325 via a threaded connection, such as a screw 331 rotatable by a knob 333.

Block 329 has an abutment wall 335 such that, when block 329 is inserted into the rod seat 327, it arranges behind the end of the picking rod 34 so as to realise a fixed abutment.

Advantageously, this allows obviating the damage to which the rod may be subject during a prolonged operation or allows using rods having different length according to the product requirements.

Innovatively, the riveting apparatus according to the present invention overcomes the drawbacks of the prior art as it allows performing rivet insertion and riveting operations at high speed and with excellent accuracy.

Advantageously, moreover, the apparatus has limited dimensions, due to the integration between the rivet insertion device and the riveting device.

According to a further advantageous aspect, the apparatus is particularly strong and reliable, for example due to the closed-loop structure of the frame or for example due to the abutment of the riveting action against a fixed abutment, such as the vertical shoulder.

According to an even further advantageous aspect, the apparatus has a high productivity, as jams or other stops of the device are infrequent, due for example to the rivet being accompanied during the insertion.

It is clear that a man skilled in the art may make changes to the apparatus described above in order to meet incidental needs, all falling within the scope of protection defined in the following claims.

1. Riveting apparatus (1) for the application and riveting a rivet (6) to a component (2, 4) of an article (1a, 1b) being processed in a work region (96) of the apparatus, comprising a rivet insertion device (30) for the insertion of the rivet into the component and a riveting device (40) for the riveting of said rivet.

2. Riveting apparatus according to any of the preceding claims, wherein
the rivet insertion device (30) comprises a picking group (32) provided with a picking rod (34) having extension and translatable along a picking direction (Z1);
the riveting device (40) comprises a riveting head (42) suitable to plastically deform the free end of the rivet (6) and translatable along a riveting direction (Z2) parallel to the picking direction (Z1);
said apparatus further comprises a rivet feed group (60) suitable to engage the rivet (6) and position it with the shank (6b) along an insertion direction (Z3), parallel to the riveting direction (Z2) and to the picking direction (Z1);
wherein the picking group (32) and the riveting device are arranged on one side of the work region (96), and the rivet feed group (60) is arranged on the other side of said region (96).

3. Riveting apparatus according to claim 4, wherein said rivet insertion device (30) and said riveting device (40) are mutually integral in translation along a longitudinal direction (U) orthogonal to the picking direction (Z1) and to the riveting direction (Z2) and translatable along said longitudinal direction (U) to alternately align the picking direction (Z1) or the riveting direction (Z2) to the insertion direction (Z3).

4. Riveting apparatus according to claim 3, comprising a mobile support (52) translatable along said longitudinal direction (U), said rivet insertion device (30) and said riveting device (40) being arranged on board said mobile support (52).

5. Riveting apparatus according to any of claims 2 to 4, wherein the riveting head (42) comprises a tip (44) having prevailing extension along a tip axis (Q) inclined with respect to the riveting direction (Z2).

6. Riveting apparatus according to any of claims 2 to 5, comprising an insertion and abutment group (70) that cooperates with the picking group (32) for the insertion of the rivet (6) into a hole (4a) of the article (1a, 1b) and with the riveting head (42) for the riveting of said rivet (6), wherein said insertion and abutment group (70) comprises a main rod (72) coaxial with the insertion direction (Z3) and translatable along said direction (Z3).

7. Riveting apparatus according to claim 6, wherein the insertion and abutment group (70) comprises cam movement means (74) for moving the main rod (72).

8. Riveting apparatus according to claim 7, wherein the cam movement means (74) comprise a cam (76) translatable between a first limit position, for example lowered, which corresponds to a retracted limit position of the main rod (72) and a second limit position, for example raised, which corresponds to an advanced limit position of the main rod (72).

9. Riveting apparatus according to claim 8, wherein the cam (76), in the direction orthogonal to the insertion direction (Z3), is in abutment with a fixed shoulder (84) applied to the vertical shoulder (18) of the frame (12).

10. Riveting apparatus according to any of the preceding claims, comprising lifting means (98) operable to lift a pallet (90) bearing the article (1a, 1b) to a predefined height.

11. Apparatus according to claim 10, wherein said lifting means (98) comprise interchangeable blocks (100, 102) that realise an end stop for a piston of the lifting means, to position the article (1) at the desired height.

12. Apparatus according to any of the preceding claims, comprising means for measuring the length of the rivet.

13. Apparatus according to any of the preceding claims, comprising means for measuring the hardness of the rivet.

14. Working method of a riveting apparatus, comprising the steps of:
inserting a rivet (6) in a component (2, 4) of an article (1a, 1b) being processed, by means of a picking group (32) having a picking direction (Z1) and an insertion and abutment group (70) having an insertion direction (Z3);
translating the picking group (32) and translating integrally to this a riveting head (42) having a riveting direction (Z2), so as to align the riveting direction (Z2) to the insertion direction (Z3);
perform the riveting of a free end of the rivet (6) by translation of the riveting head (42) along said riveting direction (Z2), maintaining a main rod (72) of the insertion and abutment group (70) in abutment with a head (6a) of the rivet (6), opposite the riveted end.
